(19) United States
(12) Patent Application Publication
(10) Pub. No.: US 2006/0205384 A1
(43) Pub. Date: Sep. 14, 2006

(54) Method of security monitoring and alarming using mobile voice device

(76) Inventor: Chih Yuan Chang, Taipei (TW)

Correspondence Address: LIN & ASSOCIATES INTELLECTUAL PROPERTY, P.O. BOX 2339, SARATOGA, CA, 95070-0339, US

(21) Appl. No.: 11/076,802

(22) Filed: Mar. 10, 2005

(51) Int. Cl. H04M 3/16

(52) U.S. Cl. 455/410; 455/570

(57) ABSTRACT

A method utilizing a mobile handset (or a PDA capable of collecting voices, playing voices, and making voice calls over a mobile communications network) to conduct security monitoring, alarming, and logging is provided. The method allows a user to turn his or her mobile handset into intrusion detection, alarming, and logging device when the user is alone at home or during the night. The method utilizes the handset's microphone to collect surrounding noise and, if the handset has a camera, the method could also utilize the camera to capture images. By analyzing the collected noise and/or captured images, the method could detect if there is some intruder breaking into the house. The method then plays a pre-recorded voice/audio via the handset's speaker to scare the intruder. The method could also automatically send out short messages and/or making voice call to ask for help. In addition, the method could transmit a record of the incident's scenario to another handset or a remote computer using the handset's recording capability for subsequent investigation.

### BACKGROUND OF THE INVENTION

1. Field of the Invention

The present invention generally relates to security monitoring, and more particularly to a method utilizing a mobile voice device for security monitoring, alarming, and logging.

2. The Prior Arts

Establishing a secured household is always a concern to everyone. However, home security is not cheap and it is not everyone could afford. Installing home security appliances or using security services is quite expensive. Moreover, when there is indeed some urgent condition happening, whether these costly measures could really function as expected at the time of need is not questionable.

On the other hand, the explosive growth of mobile communications has made mobile handset a necessity to almost everyone. As the technologies evolve, mobile handsets have also upgraded themselves from simple voice communication devices to personal handheld entertainment centers. For example, mobile handsets capable of MP3 music playing and mobile handsets with cameras capable video recording and picture taking are gaining widespread popularity.

In some sense these multimedia handsets are pretty much equipped with the basic necessary hardware and functions, such as voice and video recording, required for security monitoring. There is therefore an idea to turn a mobile handset, which almost every person has one, into a security monitoring, alarming, and logging device.

### SUMMARY OF THE INVENTION

The present invention allows a mobile handset user to utilize his or her handset as an automatic security monitoring, alarming, and logging device when the user is alone at home and when the user goes to bed at night.

The present invention provides a method of security monitoring, alarming, and logging using a mobile voice device. The mobile voice device includes mobile handsets, PDAs, or similar devices that are capable of capturing images (such as picture taking), receiving and recording voices, playing voice and audio clips, and mobile voice communications.

The method of the present invention is implemented and installed in a mobile voice device as a software module. To use the method, a user first places the mobile voice device at an appropriate location in the environment to be monitored, and then activates the method via the mobile voice device's built-in human-machine interface. The method allows user choices of different types of monitoring mechanism that are most suitable to the monitored environment. For example, during the day time or where the lights are bright enough for the mobile voice device to receive clear images, the user could choose to use motion detection for discovering disturbance in the monitored environment. During the night or where there is not enough light, the user could choose to use noise detection for surveillance. The user could also choose to use both motion and noise detection simultaneously.

For noise detection, the present invention first listens to the surrounding environment for a period of time so as to establish some criteria for the monitored environment (such as the frequency range and the volume of the environmental noise). The mobile voice device then enters a surveillance mode. Whenever there is an unusual noise, probably due to some intruder breaking into the house or any other reason, and the noise differs from the criteria up to a certain degree, the present invention could trigger a number of alarms. The present invention could immediately play a pre-recorded siren sound or voice clip via the mobile voice device's speaker so as to scare the intruder. The present invention could also automatically report such incident to a friend or the authority by sending a pre-determined short message to at least one specific receiver. In addition, the present invention could also automatically dial at least a specific phone number and, when the called party answers the call, the present invention plays a pre-recorded voice clip to report the incident or ask for help. One possible scenario is to dial 911 and automatically report the user's name, address, and the situation.

For mobile voice devices equipped with cameras, the present invention could also utilize the devices' image capturing capability for motion detection in the monitored environment. Similar to the noise detection, the present invention first watches the surrounding environment for a period of time so as to establish some criteria for the monitored environment (such as the stationary areas, brightness, and colors in the surrounding). The mobile voice device then enters a surveillance mode. Whenever there is an unusual object movement, the present invention could trigger one or more of the aforementioned alarms.

After the detection of the abnormal conditions, the present invention could also activate the voice and/or video recording function of the mobile voice device, so as to log the intruder's accent, image, and the scenario of the incident. The recordings could be saved in the mobile voice device itself, transmitted to another mobile voice device via the mobile communications network, or transmitted to a remote server for storage. For the two surveillance modes of the present invention, a user could choose to use only one of them, or the user could use both the motion detection and noise detection together.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a flow chart showing the operation steps of a first embodiment of the present invention.

FIG. 2 is a flow chart showing the operation steps of a second embodiment of the present invention.

FIG. 3 is a schematic diagram showing a style of voice and logging according an embodiment of the present invention.

### DETAILED DESCRIPTION OF THE PREFERRED EMBODIMENTS

In the following, detailed description along with the accompanied drawings is given to better explain preferred embodiments of the present invention. Please be noted that, in the accompanied drawings, some parts are not drawn to scale or are somewhat exaggerated, so that people skilled in the art can better understand the principles of the present invention.

The present invention is a method utilizing a mobile voice device for security monitoring, alarming, and logging. The so-called mobile voice device here refers to a mobile handset, a PDA capable of mobile voice communications, or a similar electronic handheld device.

The mobile voice device is required to have three basic functions for the application of the present invention. The mobile voice device should be able to collect audio signals (for example, via the microphone of the device), to play an audio signal (for example, via the speaker of the device), and to conduct voice communications over a mobile communications network (namely, the device must have a human-machine interface such as screen and keypad for dialing, and device must be able to send short messages). A PDA usually does not have the three functions built-in. But the three functions could be incorporated into a PDA by some add-on modules. For example, a PDA could have a GSM module installed so as to become a “PDA phone.”

The present invention is implemented as a software module installed inside a mobile voice device. Depending on the mobile voice device, the present invention could be installed using one of the following approaches. For mobile voice devices using a proprietary operating system (for example, the so-called Feature Phones are commonly using proprietary operating systems), the present invention could be built into the proprietary operating system when the mobile voice devices are manufactured. For mobile voice devices using a standard operating system such as Symbian®, WinCE®, PalmOS® (for example, most PDAs or so-called Smart Phones are commonly using standard operating systems), the present invention could be installed from a computer into the mobile voice device via an interface supported by the mobile voice device. Commonly supported interfaces between a mobile voice device and a computer include the USB connection, the serial connection, or the wireless connection such as IrDA or Bluetooth to a remote device. For mobile voice devices using a standard operating system, the present invention could also be installed by having the mobile voice devices connect to a remote server via a data connection (such as GPRS) to the mobile communication network and download the present invention via protocols such as WAP. It should be noted that for the foregoing installation methods to work, the mobile voice devices must have an appropriate interface (for example, IrDA, etc.) and must support the appropriate communications protocols (for example, WAP and GPRS, etc.).

To use the present invention for security monitoring, first, a user places a mobile voice device equipped with the present invention at an appropriate location (for example, facing a door or window most possible to get broken in) in the monitored environment. The user then activates the present invention via the device's human-machine interface. Using a mobile handset as an example, such activation involves using the handset keypad to navigate a menu displayed on the handset screen. Using a PDA as an example, such activation involves using the PDA stylus to tap and operate a menu displayed on the PDA screen. The present invention could be de-activated in the same way. In some embodiments of the present invention, a user could use the same human-machine interface to configure the present invention, such that the present invention is automatically activated and/or deactivated at specific points of time. For example, the present invention could be set to start monitoring automatically at midnight and stop monitoring at six in the morning every day.

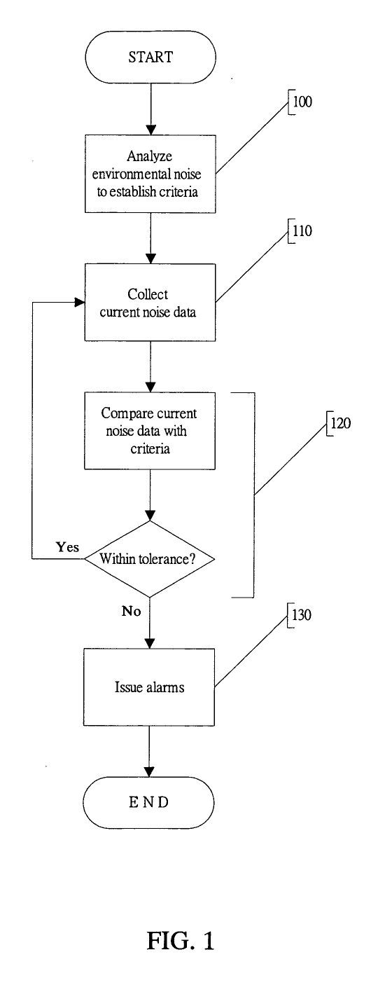

FIG. 1 is a flow chart showing the operation steps of a first embodiment of the present invention. As illustrated, the present embodiment after been activated listens to the surrounding environment for a period of time at step 100. The length of the period is pre-determined. The present embodiment utilizes the collected noise data during this period of time, calculates, and establishes the criteria for determining whether an abnormal condition has occurred. Then, in step 110, the present embodiment enters a surveillance mode and continues to listen to the surrounding environment via the device's microphone. Within step 120, the present embodiment compares the currently collected noise data with the criteria obtained from step 100. If the two's difference is within a pre-determined range or tolerance, the present embodiment continues its monitoring.

The tolerance is configurable by the user via the device's human machine interface. Otherwise the present embodiment would use a pre-determined or a default range. In some embodiments of the present invention, the tolerance could be represented by numerical values or ranges of values. In some other embodiments, for example, the tolerance is represented by one of three possible sensitivities: Low, Mid, and High. The Low sensitivity means only a rather loud noise could trigger the mobile voice device. On the other hand, the High sensitivity means a small noise could trigger the mobile voice device.

When there is some noise in the monitored environment, probably due to intrusion or other reason, exceeding the criteria's tolerance, the present embodiment starts to issue alarms in step 130. The present embodiment provides three types of alarms. First, the present embodiment could play one or more pre-recorded audio or voice clips (such as a siren sound or a voice message) through the speaker to scare the intruder. Secondly, the present embodiment could send out a pre-determined short message to at least one specific receiver. Thirdly, the present embodiment could dial at least one specific number and, when the called party picks up, play a pre-recorded audio or voice clip (for example, the present embodiment could dial 911 and report the user's name, address, etc.). In the present embodiment, the user could configure to issue all three types of alarms or only one of them when abnormal condition occurs. If the user does not have any specification, the present embodiment uses the playing of pre-recorded audio/voice clips as the default type of alarm.

The content of the foregoing three types of alarms such as the dialing numbers, short messages, or pre-recorded voice/audio clips is configurable by the user. Among them, the pre-recorded voice/audio clips could have a number of sources. The voice/audio clips could be an integral part of the software module, and they are installed into the mobile voice device along with the software module of the present embodiment. In some cases where the mobile voice device has some built-in voice/audio clips, some embodiments of the present invention could directly use these voice/audio clips if they are available for access. For some other embodiments, the voice/audio clips are downloaded into the mobile device from a computer. Please note that, depending on the support of the mobile voice device, not all of foregoing sources are available. The voice/audio clips could also be played in different styles. In some embodiments, one or more of the clips are played sequentially for only once while, in other embodiments, they are played sequentially and repeatedly in a round-robin fashion. The dialing out and sending short messages could also be conducted in different styles. For example, instead of sending to a single receiver, some embodiments send out short messages to multiple receivers sequentially. In addition, each specific receiver or dialed number could have a specific, corresponding short message or voice/audio clips. It is therefore possible to send short message A′ to receiver A, short message B′ to receiver B, and to play voice/audio clip C′ when dialing number C, voice/audio clip D′ when dialing number D, and so on.

Besides the foregoing, different types of alarms, for mobile voice devices capable of voice recording, the present embodiment also provides a voice logging function. In other words, when the present embodiment detects some abnormal condition (namely, a noise exceeding the tolerance), it starts to record whatever it receives from the device's microphone. This is a valuable function as the scenario of an incident is preserved and, if there is a crime committed, the voice logging would be very helpful to the subsequent investigation. Voice logging could also be conducted in three different styles. First, the recorded voice is saved in a memory device of the mobile voice device (for example, a built-in memory or a memory card). The voice logging is conducted continuously until the memory device is full. A variation to this continuous recording is that, when the memory device is full, the recorded voice is then saved to the start of the memory device, therefore, overwriting the earlier recordings. This round-robin process is repeated over and over. Yet another variation is that the voice logging is conducted up to a pre-determined time interval. The user could specify one of the three variations (continuous recording, round-robin recording, and timed recording). If the user does not specify a specific one, the present embodiment could use one as default. During the voice logging, the user could interrupt and terminate the recording at any time.

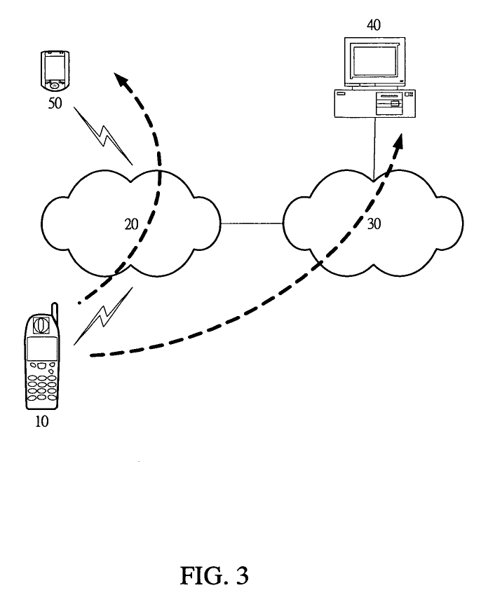

For a second style of voice logging, please refer to FIG. 3. As illustrated, if the mobile voice device has a data communications capability (such as supporting GPRS and WAP), the recorded voice could be transmitted to a server 40 on the Internet 30 synchronously, continuously, and in real time. Please note that the term server refers to any computing device playing a server role in a client-server type of interaction. The server 40 therefore could be a notebook computer, a PDA, or even another mobile voice device. The server 40 has a reserved space for the storage of the recorded voice received. For this style of voice logging, there are also three variations: continuous recording (until the reserved space is full), round-robin recording (repeatedly using the reserved space), and timed recording. Again, the user could specify one of the three variations, or the present embodiment would use a pre-determined one as default. Please note that the start and stop of recording and transmission requires the mobile voice device 10 and the server 40 to communicate according to a specific protocol, so that, for example, the mobile voice device 10 could know if the reserved space is full. In addition, the present embodiment provides relevant settings for the user to configure parameters such as server 40 IP address, port number, ID and password for logging into the server 40, etc. During the voice logging, the user could interrupt and terminate the recording at any time.

Also as illustrated in FIG. 3, a third style of voice logging is to dial another mobile voice device 50 and, when the remote mobile voice device 50 answers the call, transmit the recorded voice to the remote mobile voice device 50 via the mobile communications network 20 synchronously, continuously, and in real time. The one answering the remote mobile voice device 50 could hear whatever happens on the side of the local mobile voice device 10. For this style of voice logging, the recording is continued until the remote mobile voice device 50 hangs up, or the user of local mobile voice device 10 terminates the voice logging. In addition, the present embodiment provides relevant settings for the user to configure parameters such as the phone number of the remote mobile voice device 50, etc. The user could specify one of the three styles of voice logging (local memory, remote server, and remote phone), or the present embodiment would use one as default. In some embodiments the three styles are mixed. For example, the recorded voice is first saved to the device's memory and, when the memory is full, then saved to a server on the Internet.

When an abnormal condition (namely, a noise exceeding the tolerance) is detected, some embodiments conduct only alarming functions, some conduct only voice logging, and some (such as the present embodiment) conduct both alarming and voice logging. Whether to conduct alarming and voice logging is configurable by the user, or the present embodiment could have a default mode. For example, the default of present embodiment is to conduct alarming only. Please note that the foregoing alarming and voice logging, if enabled by the user, would automatically start when an abnormal condition is detected. At any point of time, the user could use the human-machine interface of the mobile voice device, such as pressing a specific key, to terminate the alarming and voice logging.

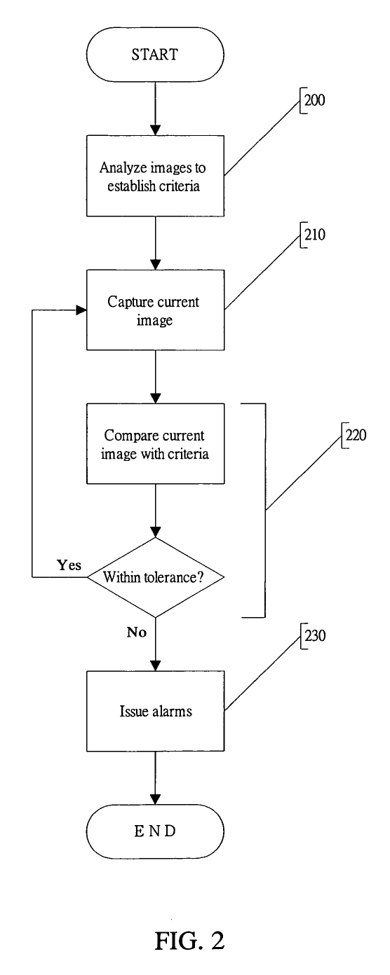

FIG. 2 is a flow chart showing the operation steps of a second embodiment of the present invention. The present embodiment utilizes a mobile voice device having a camera for image capturing, in addition to the three basic functions (namely, collection of audio signals, playing of audio signals, mobile voice communications). For these so-called Camera Phones, the present embodiment could provide three types of security monitoring: noise detection only (as in the first embodiment), motion detection only, or both. For simplicity, the present embodiment conducts only motion detection. For security monitoring involving both noise and motion detections, as it could be easily inferred from explanation to the previous and the present embodiments, its explanation is omitted here.

Similar to the first embodiment, first, a user places a mobile voice device equipped with the present embodiment at an appropriate location and aims the camera at a door or window that most possible to get broken in. The user then activates the present embodiment via the device's human-machine interface. The present embodiment could also be scheduled to start and stop automatically.

As shown in FIG. 2, in step 200, the present embodiment after been activated continuously collects images for a period of time. The length of the period is pre-determined. The present embodiment utilizes the collected image data during this period of time, calculates, and establishes the criteria for determining whether an abnormal condition has occurred. Then, in step 210, the present embodiment enters a surveillance mode and continues to collect image data via the device's camera. Within step 220, the present embodiment compares the currently collected image data with the criteria obtained from step 200. If the two's difference is within a pre-determined range or tolerance, the present embodiment continues its monitoring. On the other hand, if there is some image change in the monitored environment, probably due to intrusion or other reason, exceeding the criteria's tolerance, the present embodiment starts to issue alarms in step 230.

Similar to the first embodiment, the present embodiment provides the same three types of alarms. In addition, the present embodiment also provides a video logging function. In other words, when the present embodiment detects some abnormal condition (namely, some image change exceeding the tolerance), it starts to record whatever it receives from the device's camera. Again, this is a valuable function for the subsequent investigation. Video logging could also be conducted in three different styles. First, the recorded video is saved in a memory device of the mobile voice device (for example, a built-in memory or a memory card). There are also three variations: continuous recording (until the memory device is full), round-robin recording (repeatedly using the memory device's space), and timed recording. If the user does not specify a specific one, the present embodiment would use a pre-determined one as default. During the video logging, the user could interrupt and terminate the recording at any time.

For a second style of video logging, if the mobile voice device has a data communications capability (such as supporting GPRS and WAP), the recorded video could be transmitted to a server on the Internet synchronously, continuously, and in real time. Please note that the term server refers to any computing device playing a server role in a client-server type of interaction. The server therefore could be a notebook computer, a PDA, or even another mobile voice device. The server has a reserved space for the storage of the recorded video received. For this style of video logging, there are also three variations: continuous recording (until the reserved space is full), round-robin recording (repeatedly using the reserved space), and timed recording. Again, the user could specify one of the three variations, or the present embodiment would use a pre-determined one as default. Please note that the start and stop of recording and transmission requires the mobile voice device and the server to communicate according to a specific protocol, so that, for example, the mobile voice device could know if the reserved space is full. In addition, the present embodiment provides relevant settings for the user to configure parameters such as server IP address, port number, ID and password for logging into the server, etc. During the video logging, the user could interrupt and terminate the recording at any time.

A third style of video logging is to dial another mobile voice device and, when the remote mobile voice device answers the call, transmit the recorded video to the remote mobile voice device via the mobile communications network synchronously, continuously, and in real time. The one answering the remote mobile voice device could see whatever happens on the local side. For this style of video logging, the recording is continued until the remote mobile voice device 50 hangs up, or the user of local mobile voice device terminates the video logging. In addition, the present embodiment provides relevant settings for the user to configure parameters such as the phone number of the remote mobile voice device, etc. The user could specify one of the three styles of video logging (local memory, remote server, and remote phone), or the present embodiment would use one as default. In some embodiments the three styles are mixed. For example, the recorded video is first saved to the device's memory and, when the memory is full, then saved to a server on the Internet.

When an abnormal condition (namely, an image change exceeding the tolerance) is detected, some embodiments conduct only alarming functions, some conduct only video logging, and some (such as the present embodiment) conduct both alarming and video logging. Whether to conduct alarming and video logging is configurable by the user, or the present embodiment could have a default mode. For example, the default of present embodiment is to conduct alarming only. Please note that the foregoing alarming and video logging, if enabled by the user, would automatically start when an abnormal condition is detected. At any point of time, the user could use the human-machine interface of the mobile voice device, such as pressing a specific key, to terminate the alarming and video logging.

In some embodiments of the present invention, when the mobile voice device is already in the process of security monitoring (using noise detection, motion detection, or both), if some urgency has occurred, the user could use the device's human-machine interface such as continuously pressing a specific key for a period of time to immediately activate the configured alarming and/or logging functions manually. In some embodiments, this manual activation could further use different keys to activate different alarming and/or logging functions respectively. For example, long-pressing the digit key 9 would issue the short message as configured; long-pressing the digit key 8 would dial out and ask for help.

Please note that, in the foregoing description, the computational algorithms for noise and image data analysis/comparison is not clearly specified, as theoretically any effective, known algorithm could be adopted. For example, an embodiment could use the simplest image comparison algorithm, which compares one image's pixels to another image's corresponding pixels. Another embodiment could use more advanced algorithms based on pixels' chromatic difference and block-based comparison using compressing techniques. The actual choice of algorithms should also consider the mobile voice device's computational capacity. In some embodiments of the present invention, the choice of several algorithms could also be a user configurable parameter, through which the user could strike a balance between detection accuracy and device responsiveness.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method utilizing a mobile voice device for security monitoring, alarming, and logging; said mobile voice device being an electronic device at least capable of collecting audio signals, playing audio signals, sending short messages, and making voice calls over mobile communications networks; and, after being activated, said method comprising at least steps of:
collecting noise data from a surrounding environment via a microphone of said mobile voice device for a period of time, and analyzing said noise data to establish criteria;
collecting current noise data from said surrounding environment via said microphone of said mobile voice device;
comparing said current noise data to said criteria, returning to the previous step if the difference is within a pre-determined tolerance, or continuing with the next step if the difference exceeds said pre-determined tolerance; and
utilizing said mobile voice device's capability of collecting audio signals, playing audio signals, sending short messages, and making voice calls over mobile communications networks to conduct a type of alarming and logging operation selected from the following three types of operations: issuing a type of alarm only; performing a type of logging only; and issuing a type of alarm and performing a type of logging simultaneously.

2. The method as claimed in claim 1, wherein said mobile voice device is one of the following two devices: a mobile handset and a PDA capable of collecting audio signals, playing audio signals, sending short messages, and making voice calls over mobile communications networks.

3. The method as claimed in claim 1, wherein said method is a software module built in an operating system of said mobile voice device.

4. The method as claimed in claim 1, wherein said method is a software module downloaded into said mobile voice device via a connection between said mobile voice device and a computing device.

5. The method as claimed in claim 1, wherein said method is a software module downloaded into said mobile voice device via a data connection between said mobile voice device and a remote server through a mobile communications network.

6. The method as claimed in claim 1, wherein said method is activated and de-activated by a user manually through a human-machine interface of said mobile voice device.

7. The method as claimed in claim 1, wherein said method is activated and de-activated automatically by said mobile voice device according to a schedule pre-configured by a user.

8. The method as claimed in claim 1, wherein said tolerance is pre-determined by a user's choosing one of a plurality of pre-determined settings and, if said tolerance is not specified, a default tolerance is used.

9. The method as claimed in claim 1, wherein said type of alarming and logging operation is pre-determined by a user and, if said type of alarming and logging operation is not specified, a default type of alarming and logging operation is used.

10. The method as claimed in claim 1, wherein said type of alarm is to play via said mobile voice device's speaker sequentially and continuously at least a pre-recorded voice/audio clip pre-determined by a user.

11. The method as claimed in claim 1, wherein said type of alarm is to send a pre-determined short message to at least a pre-determined receiver via a mobile communications network and, if there are a plurality of receivers, each receiver is sent a specific, pre-determined short message respectively.

12. The method as claimed in claim 1, wherein said type of alarm is to dial at least a pre-determined number and, when a called party answers, play at least a pre-recorded and pre-determined voice/audio clip, and, if there are a plurality of numbers, each number is dialed and played with a specific, pre-determined voice/audio clip respectively.

13. The method as claimed in claim 1, wherein said type of logging is to record and save whatever received from said microphone of said mobile voice device synchronously to a memory device of said mobile voice device in real time.

14. The method as claimed in claim 13, wherein said type of logging is conducted according to one of the following three styles: records until said memory device is full and then stops automatically; records continuously until reaching the end of said memory device, returning to the start of said memory device, and gradually overwriting the previously recorded content; and records up to a pre-determined time interval.

15. The method as claimed in claim 1, wherein said type of logging is to record whatever received from said microphone of said mobile voice device and synchronously transmit and save to a storage space of a server in the Internet according to a protocol via a data connection between said mobile voice device and said server in real time.

16. The method as claimed in claim 15, wherein said type of logging is conducted according to one of the following three styles: records until said storage space is full and then stops automatically; records continuously until reaching the end of said storage space, returning to the start of said storage space, and gradually overwriting the previously recorded content; and records up to a pre-determined time interval.

17. The method as claimed in claim 1, wherein said type of logging is to call a remote mobile voice device via a mobile communications network and, when said remote mobile voice device is answered, synchronously transmit whatever received from said microphone of said mobile voice device in real time.

18. The method as claimed in claim 17, wherein said type of logging is conducted until said remote mobile voice device hangs up.

19. The method as claimed in claim 1, wherein said type of alarming and logging operation is activated immediately and manually by a user's pressing a specific key of said mobile voice device for a period of time.

20. The method as claimed in claim 1, wherein a specific type of alarming and logging operation is activated immediately and manually by a user's pressing a specific corresponding key of said mobile voice device for a period of time.

21. The method as claimed in claim 1, wherein said type of alarming and logging operation is terminated any time by a user via a human-machine interface of said mobile voice device.

22. A method utilizing a mobile voice device for security monitoring, alarming, and logging; said mobile voice device being an electronic device at least capable of image capturing, collecting audio signals, playing audio signals, sending short messages, and making voice calls over mobile communications networks; and, after being activated, said method comprising at least steps of:
collecting image data from a surrounding environment via said camera of said mobile voice device for a period of time, and analyzing said image data to establish criteria;
collecting current image data from said surrounding environment via said camera of said mobile voice device;
comparing said current image data to said criteria, returning to the previous step if the difference is within a pre-determined tolerance, or continuing with the next step if the difference exceeds said pre-determined tolerance; and
utilizing said mobile voice device's capability of collecting audio signals, playing audio signals, sending short messages, and making voice calls over mobile communications networks to conduct a type of alarming and logging operation selected from the following three types of operations: issuing a type of alarm only; performing a type of logging only; and issuing a type of alarm and performing a type of logging simultaneously.

23. The method as claimed in claim 22, wherein said mobile voice device is one of the following two devices: a mobile handset having a camera and image capturing capability, and a PDA having a camera and capable of capturing images, collecting audio signals, playing audio signals, sending short messages, and making voice calls over mobile communications networks.

24. The method as claimed in claim 22, wherein said method is a software module built in an operating system of said mobile voice device.

25. The method as claimed in claim 22, wherein said method is a software module downloaded into said mobile voice device via a connection between said mobile voice device and a computing device.

26. The method as claimed in claim 22, wherein said method is a software module downloaded into said mobile voice device via a data connection between said mobile voice device and a remote server through a mobile communications network.

27. The method as claimed in claim 22, wherein said method is activated and de-activated by a user manually through a human-machine interface of said mobile voice device.

28. The method as claimed in claim 22, wherein said method is activated and de-activated automatically by said mobile voice device according to a schedule pre-configured by a user.

29. The method as claimed in claim 22, wherein said tolerance is pre-determined by a user's choosing one of a plurality of pre-determined settings and, if said tolerance is not specified, a default tolerance is used.

30. The method as claimed in claim 22, wherein said type of alarming and logging operation is pre-determined by a user and, if said type of alarming and logging operation is not specified, a default type of alarming and logging operation is used.

31. The method as claimed in claim 22, wherein said type of alarm is to play via said mobile voice device's speaker sequentially and continuously at least a pre-recorded voice/audio clip pre-determined by a user.

32. The method as claimed in claim 22, wherein said type of alarm is to send a pre-determined short message to at least a pre-determined receiver via a mobile communications network and, if there are a plurality of receivers, each receiver is sent a specific, pre-determined short message respectively.

33. The method as claimed in claim 22, wherein said type of alarm is to dial at least a pre-determined number and, when a called party answers, play at least a pre-recorded and pre-determined voice/audio clip, and, if there are a plurality of numbers, each number is dialed and played with a specific, pre-determined voice/audio clip respectively.

34. The method as claimed in claim 22, wherein said type of logging is to record and save whatever captured from said camera of said mobile voice device synchronously to a memory device of said mobile voice device in real time.

35. The method as claimed in claim 34, wherein said type of logging is conducted according to one of the following three styles: records until said memory device is full and then stops automatically; records continuously until reaching the end of said memory device, returning to the start of said memory device, and gradually overwriting the previously recorded content; and records up to a pre-determined time interval.

36. The method as claimed in claim 22, wherein said type of logging is to record whatever captured from said camera of said mobile voice device and synchronously transmit and save to a storage space of a server in the Internet according to a protocol via a data connection between said mobile voice device and said server in real time.

37. The method as claimed in claim 36, wherein said type of logging is conducted according to one of the following three styles: records until said storage space is full and then stops automatically; records continuously until reaching the end of said storage space, returning to the start of said storage space, and gradually overwriting the previously recorded content; and records up to a pre-determined time interval.

38. The method as claimed in claim 22, wherein said type of logging is to call a remote mobile voice device via a mobile communications network and, when said remote mobile voice device is answered, synchronously transmit whatever captured from said camera of said mobile voice device in real time.

39. The method as claimed in claim 38, wherein said type of logging is conducted until said remote mobile voice device hangs up.

40. The method as claimed in claim 22, wherein said type of alarming and logging operation is activated immediately and manually by a user's pressing a specific key of said mobile voice device for a period of time.

41. The method as claimed in claim 22, wherein a specific type of alarming and logging operation is activated immediately and manually by a user's pressing a specific corresponding key of said mobile voice device for a period of time.

42. The method according to claim 22, wherein said type of alarming and logging operation is terminated any time by a user via a human-machine interface of said mobile voice device.
